(19) United States
(12) Patent Application Publication
(10) Pub. No.: US 2024/0046339 A1
(43) Pub. Date: Feb. 8, 2024

(54) PHYSICAL ITEM PROVISION MANAGEMENT DEVICE, TERMINAL, AND PHYSICAL ITEM PROVISION METHOD, PROGRAM

(71) Applicant: BANDAI CO., LTD., Tokyo (JP)

(72) Inventors: Hajime KONDO, Tokyo (JP); Tatsushi IKARASHI, Tokyo (JP); Kenichi MINAGAWA, Tokyo (JP); Hiroki KOBAYASHI, Tokyo (JP)

(21) Appl. No.: 18/488,062

(22) Filed: Oct. 17, 2023

Related U.S. Application Data
(63) Continuation of application No. 17/345,866, filed on Jun. 11, 2021, now abandoned.

(30) Foreign Application Priority Data
Jun. 18, 2020 (JP) 2020-105695

(51) Int. Cl. G06Q 30/0601; G06Q 10/083; G06Q 10/087; G06Q 20/18

(52) U.S. Cl. CPC G06Q 30/0641; G06Q 10/083; G06Q 10/087; G06Q 20/18

(57) ABSTRACT

A management apparatus comprises a processor and a non-volatile computer readable memory in which a computer code is stored, wherein, based on the computer code stored in the non-volatile memory, the processor manages an inventory status information of items, displays, on a terminal, a purchase screen for purchasing at least one of the items, performs a lottery for the at least one of the items to be provided, by using the inventory status information of the items when an item purchase procedure is completed, determines the at least one of the items to be provided based on a lottery result, and presents an item image of the determined at least one of the items on the terminal.

### CROSS REFERENCES TO RELATED APPLICATIONS

This application claims priority to Japanese Patent Application No. 2020-105695 filed in the Japan Patent Office on Jun. 18, 2020, the entire contents of which are incorporated herein by reference

### BACKGROUND

The present invention relates to a program, a physical item provision management device, a terminal, and a physical item provision method.

Conventionally, there has been an item provision device with a handle or the like that is operated for acquiring an item (capsule toy) accommodated in a device main body (JP-A-2004-334911, for example).

### SUMMARY

Recently, there have been more opportunities to purchase commodities on the Internet through an EC site, due to the widespread use of the Internet.

In view of this, the present invention provides a program, a physical item provision management device, a terminal, and a physical item provision method improving usability for users.

An aspect of the present invention is a program in a terminal communicably connected with a physical item provision management device, the program causing the terminal to function as: a display control unit capable of displaying an item image corresponding to a physical item and a container image corresponding to a container virtually accommodating the physical item and concealing the physical item; and a provision procedure control unit enabling, when the item image and the container image are displayed, a provision procedure of providing a user with the physical item corresponding to the item image displayed.

An aspect of the present invention is a physical item provision management device communicably connected with a terminal, the physical item provision management device comprising: a provision control unit capable of providing a user's terminal with an item image corresponding to a physical item and a container image corresponding to a container virtually accommodating the physical item and concealing the physical item; and a provision procedure control unit enabling, when the item image and the container image are displayed on the terminal, a provision procedure of providing the user with the physical item corresponding to the item image displayed.

An aspect of the present invention is a terminal communicably connected with a physical item provision management device, the terminal comprising: a display control unit capable of displaying an item image corresponding to a physical item and a container image corresponding to a container virtually accommodating the physical item and concealing the physical item; and a provision procedure control unit enabling, when the item image and the container image are displayed, a provision procedure of providing a user with the physical item corresponding to the item image displayed.

An aspect of the present invention is a physical item provision method for a physical item provision management device communicably connected with a terminal, the physical item provision method comprising: providing a user's terminal with an item image corresponding to a physical item and a container image corresponding to a container virtually accommodating the physical item and concealing the physical item; and performing, when the item image and the container image are displayed on the terminal, a provision procedure of providing the user with the physical item corresponding to the item image displayed.

With the present invention, items can be provided while improving usability for users.

### BRIEF DESCRIPTION OF THE DRAWINGS

FIG. 1 is a schematic view of an item provision system according to the present embodiment;

FIG. 2 is a diagram illustrating a device configuration example of a tablet computer that is an example of a terminal 2;

FIG. 3 is a diagram illustrating a capsule toy as an example of an item 3;

FIG. 4 is a block diagram illustrating a functional configuration example of an item provision management server 1;

FIG. 5 is a diagram illustrating an example of user information data D1;

FIG. 6 is a diagram illustrating an example of inventory status information data D2;

FIG. 7 is a block diagram illustrating a functional configuration example of the terminal 2;

FIG. 8 is a sequence diagram of the item provision system of the present embodiment;

FIG. 9 is a diagram illustrating an example of a screen displayed on the terminal 2;

FIG. 10 is a diagram illustrating an example of a screen displayed on the terminal 2;

FIG. 11 is a diagram illustrating an example of a screen displayed on the terminal 2;

FIG. 12 is a diagram illustrating an example of a purchase result screen displayed on the terminal 2;

FIG. 13 is a diagram illustrating an example of a delivery request screen displayed on the terminal 2;

FIG. 14 is a diagram illustrating a first modification of the embodiment of the present invention;

FIG. 15 is a diagram illustrating another example of the first modification of the embodiment of the present invention; and

FIG. 16 is a diagram illustrating a second modification of the embodiment of the present invention.

### DETAILED DESCRIPTION

### Embodiment of the Present Invention

An embodiment of the present invention will be described.

[Overall Configuration]

An item provision system according to the present embodiment will be described.

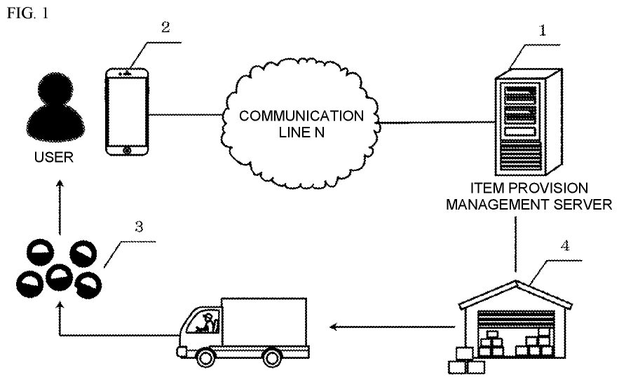

FIG. 1 is a schematic view of the item provision system according to the present embodiment. In FIG. 1, 1 denotes an item provision management server, 2 denotes a user's terminal, 3 denotes an item, and 4 denotes an item management warehouse.

The item provision management server 1, the user's terminal 2, and the item management warehouse 4 can be connected to a communication line N, and thus can communicate with each other. The communication line N is a communication path enabling data communications. Specifically, the communication line N includes a communication network such as a local area network (LAN) using a private line (private cable) for direct connection, Ethernet (registered trademark), and the like, as well as a telecommunication network, a cable network, and the Internet. The communication method may be a cable communication method or a wireless communication method.

The item provision management server 1 is a server system including one or a plurality of server apparatuses, storage devices, and the like. The item provision management server 1 provides various services for providing the item 3 to the user, acquires the inventory status of the items in the item management warehouse 4 and the like, a procedure for delivering an item to the user, and the like.

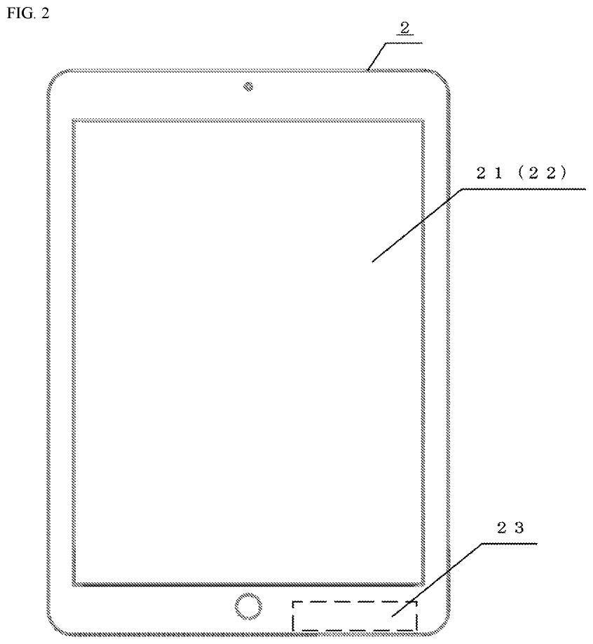

Examples of the terminal 2 include a personal computer, a tablet computer, a smartphone, a mobile phone, and the like. FIG. 2 is a diagram illustrating a device configuration example of a tablet computer that is an example of the terminal 2. As illustrated in FIG. 2, the terminal 2 includes a display 21, a touch operation panel 22 integrally configured with the display 21, and an internal speaker 23. The terminal 2 is further provided with unillustrated elements such as a control board, an internal battery, a power button, and a volume control button.

The control board contains a microprocessor of various types (e.g., a central processing unit (CPU), a graphics processing unit (GPU), and a digital signal processor (DSP)), an IC memory of various types (e.g., an application specific integrated circuit (ASIC), a video random access memory (VRAM), a random access memory (RAM), and a read only memory (ROM)), a radio communication module for wirelessly communicating with a base station, and the like. The control board further contains what is known as an interface circuit (I/F circuit) such as a driver circuit for the touch operation panel 22. These elements contained in the control board are electrically connected to each other via a bus circuit and the like, to be capable of writing and reading data to and from each other and of exchanging signals.

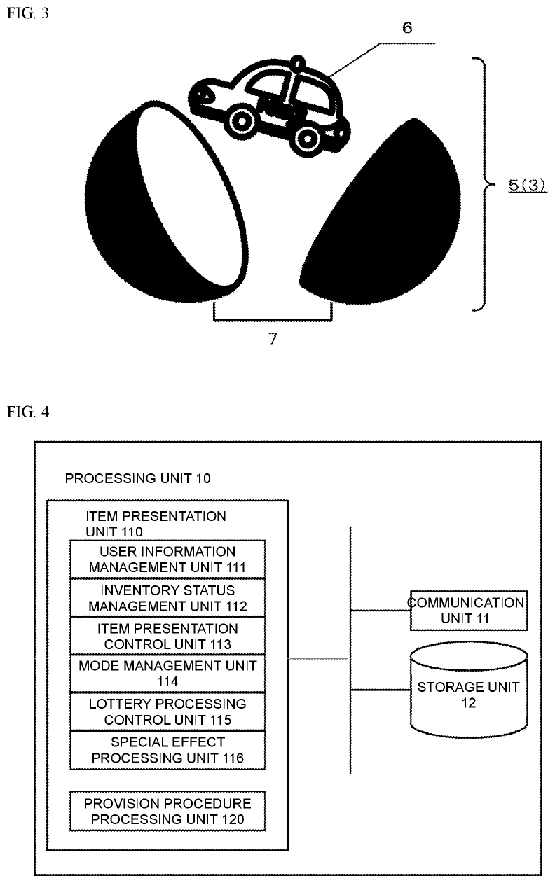

The item 3 is an item provided to the user. In the present embodiment, the item is a commodity provided to the user, when the user pays a pecuniary cost. FIG. 3 is a diagram illustrating a capsule toy as an example of the item 3. The item (commodity) 3 is a capsule toy 5 including a toy 6 and a capsule 7 that is a packaging body with which the toy 6 is packaged. It should be noted that a mode in which the toy 6 and the capsule 7 are integrated to form a single commodity (item 3) is not excluded. The packaging body is not limited to capsules. For example, the packaging body may be packaging paper, a package, or the like. The item (commodity) 3 is not necessarily an item (commodity) of a single type, and may include a plurality of types of items (commodities). Furthermore, a plurality of categories (types) may be provided for the item (commodity) 3, with a plurality of types of items (commodities) pertaining to each of the categories. When there are a plurality of types of items (commodities), rarity may be set to each of the items (commodities).

The item management warehouse 4 is a warehouse where the item 3 is stored and managed. In the item management warehouse 4, the inventory status of the item 3 is managed, and information on the inventory status of the item 3 is reported to the item provision management server 1. Furthermore, a procedure of receiving a delivery instruction from the item provision management server 1 and delivering the item 3 to the home of the user is performed.

[Functional Configuration]

A configuration of each device/apparatus will be described.

First of all, a configuration of the item provision management server 1 will be described. FIG. 4 is a block diagram illustrating a functional configuration example of the item provision management server 1.

As illustrated in FIG. 4, the item provision management server 1 includes a processing unit 10, a communication unit 11, and a storage unit 12.

The processing unit 10 performs comprehensive control on the operations of the item provision management server 1 based on the program and data stored in the storage unit 12. The function of the processing unit 10 can be implemented by electronic parts including a microprocessor such as a CPU and a GPU, an ASIC, and an IC memory. The processing unit 10 includes an item presentation unit 110 and a provision procedure processing unit 120 as main functional units.

The item presentation unit 110 is a unit that comprehensively performs processing of presenting an item to the user, and includes functions of a user information management unit 111, an inventory status management unit 112, an item presentation control unit 113, a mode management unit 114, a lottery processing control unit 115, and a special effect processing unit 116.

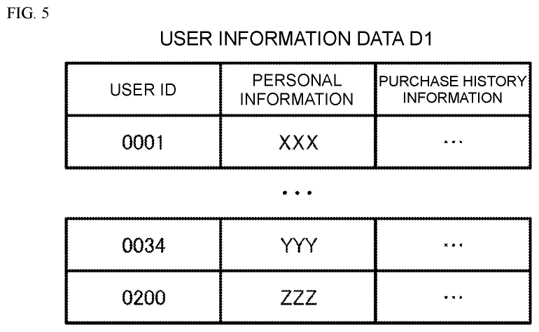

The user information management unit 111 manages information on the user by using user information data D1. The information to be managed includes: identification information (user ID) and password in a service for the user; personal information on the user such as the name and address; purchase history information on the user regarding the item (commodity) 3; and the like. The purchase history information includes item identification information on an item (commodity) 3 purchased by the user, as well as information on the purchased quantity and the purchased date of the item (commodity) 3, a cumulative amount of the cost of the item purchased by the user to date, and the like. FIG. 5 is a diagram illustrating an example of the user information data D1. In the example illustrated in FIG. 5, the user information data D1 is a table in which the user ID of the user, the personal information on the user, and the purchase history information on the user are associated with each other.

The inventory status management unit 112 manages the inventory status of the item (commodity) 3 by using inventory status information data D2. The inventory status information data D2 is also used for managing the type of the item (commodity) 3.

The item (commodity) 3 is not necessarily limited to an item (commodity) of a single type only, and includes a plurality of types of items (commodities). Furthermore, a plurality of categories (types) of items (commodities) 3 are provided, with a plurality of types of items (commodities) pertaining to each categories. When there are a plurality of types of items (commodities), rarity is set for each of the items (commodities). In the present embodiment, an example is described in which a plurality of categories are provided, a plurality of types of items (commodities) pertain to each categories, and item identification information (item ID) and rarity are set for each type of item (commodity).

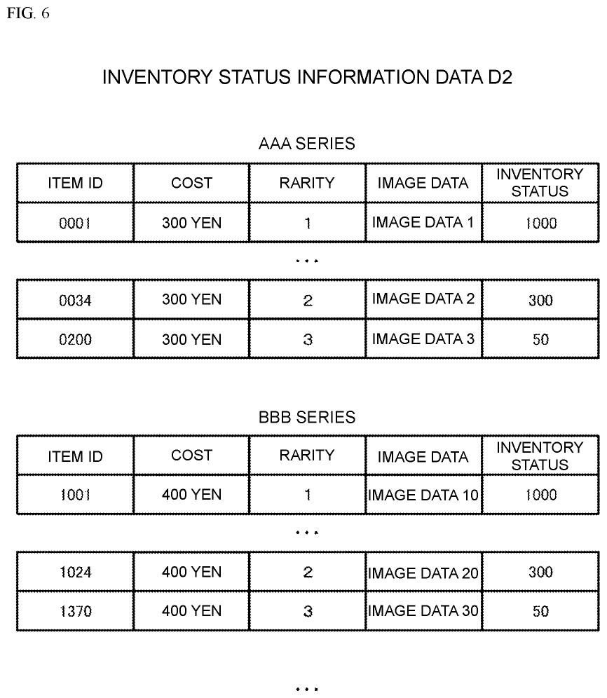

The inventory status information data D2 includes a table in which the information on and the inventory status of the item (commodity) are recorded for each categories. FIG. 6 is a diagram illustrating an example of the inventory status information data D2. In the inventory status information data D2 illustrated in FIG. 6, tables for a plurality of categories (AAA categories, BBB categories . . . ) are prepared. A table for each categories stores the item ID of each item (commodity) pertaining to the categories, the cost (price) of the item (commodity), the rarity of the item (commodity), image data on the item (commodity), and the inventory status (quantity) in association with each other.

The inventory status management unit 112 updates the inventory status information data D2 each time a new item (commodity) is added or each time the inventory status of the item (commodity) changes.

The item presentation control unit 113 comprehensively performs an operation of presenting the item (commodity) 3 to the terminal 2, by cooperating with other units.

The mode management unit 114 manages a method of providing the item (commodity) 3. In the present embodiment, a first mode for a case where the user purchases a single item (commodity) 3 and a second mode for a case where a plurality of (for example, 10) items (commodities) 3 are purchased at once are available. A cost for selecting the second mode is set to be higher than that for selecting the first mode, because the second mode provides a plurality of items. The mode management unit 114 controls the terminal 2 to allow the user to select any one of the first mode and the second mode.

The lottery processing control unit 115 performs a lottery for determining an item (commodity) 3 provided to the user, from a plurality of items (commodities) 3. A method for the lottery includes various methods, and the following methods are contemplated.

(1) A method of randomly extracting from a plurality of items (commodities) 3 pertaining to the categories selected by the user. In this case, the extraction probability set is equal among the items (commodities) 3 pertaining to the categories.

(2) A method of changing the extraction probability depending on the rarity set to the item (commodity) 3. An example is assumed where the 10 types (item ID 1 to item ID 10) of items (commodities) 3 pertain to the categories. Among these, the item ID 1 to the item ID 7 have rarity of 1 set, the item ID 8 and the item ID 9 have rarity of 2 set, and the item ID 10 has rarity 3 set (higher rarity for larger value). Under this condition, an item with higher rarity may have a lower extraction probability set, to be more difficult to be provided to the user. For example, with the extraction probability set to be 12/100 for the item ID 1 to the item ID 7 with the rarity of 1, set to be 7/100 for the item ID 8 and the item ID 9 with the rarity of 2, and set to be 2/100 for the item ID 10 with the rarity of 3, an item (commodity) 3 with higher rarity is difficult to select.

(3) A method of reflecting the type of the item purchased and acquired by the user in the past on the lottery. For this service, the user information management unit 111 of the item provision management server 1 manages the purchase history information on each user, so that the type of the item (commodity) 3 that has been acquired by the user to date can be recognized. In view of this, the method of reflecting the purchase history information on the user on the extraction probability can be used. For example, a method may be employed so that the lottery is performed so that the item (commodity) 3 to be newly provided does not overlap with the item (commodity) 3 that has been acquired in the past and thus is already possessed. For example, a method may be contemplated in which the item (commodity) 3 to be provided is selected through a lottery involving items (commodities) 3 pertaining to the categories selected by the user, excluding the already possessed item (commodity) 3.

(4) The inventory status of the current item (commodity) 3 may be reflected on the lottery. For example, a method of setting a lower extraction probability for an item (commodity) 3 with a lower inventory, and setting a higher extraction probability for an item (commodity) 3 with a higher inventory. For example, a method of weighting a value reflecting the inventory, with respect to the original extraction probability may be employed.

Furthermore, when the second mode is selected, the lottery processing control unit 115 adjusts a matching rate indicating a rate of matching between the types of the items (commodities) 3 provided at once. For example, when the matching rate is 0, each time a lottery is performed for a single item (commodity) 3, the item (commodity) 3 that has been selected by the previous lottery is excluded so that the lottery is performed with the items (commodities) 3 of the remaining types. A detailed description is given assuming the following condition. Specifically, 10 types (item ID 1 to item ID 10) of items (commodities) 3 pertain to the categories, the second mode is selected, and 10 items (commodities) 3 are provided at once. Under such a condition, when the item ID 3 is first selected by a lottery, the next lottery is performed with the items (commodities) 3 with the item ID 1, the item ID 2, and the item IDs 4 to 10, excluding the item ID 3. Thus, a multiple items (commodities) 3 can be provided at once with no identical, matching items (commodities) 3 provided.

The matching rate may be adjusted with reference to the past purchase history of the user. For example, the adjustment is performed to prevent the newly provided item (commodity) 3 from matching the item (commodity) 3 that has been acquired in the past and thus is already possessed. In such a case, the lottery is performed with the items (commodities) 3 pertaining to the categories selected by the user, excluding the item (commodity) 3 already possessed. Furthermore, the inventory status of the current item (commodity) 3 may be taken into consideration.

However, the method of adjusting the matching rate is not limited to this. Furthermore, the adjustment does not necessarily need to be performed to prevent any matching among the types of all the items provided. Thus, matching among types of some of the items may be tolerated.

The special effect processing unit 116 provides a special effect corresponding to an item (commodity) 3, when the user operates an image of the item provision device, when the user opens the packaging body (when the item (commodity) 3 concealed in the packaging body becomes visible), and in the other like situations. Possible special effects include a change in a still image, movie, sound, or color, or the like.

The provision procedure processing unit 120 performs a provision procedure after the purchasing of the item (commodity) 3 has been completed. Specifically, when the item (commodity) 3 provided to the user is determined, a procedure is performed for a destination and a delivery timing of the item (commodity) 3. The address registered in the user information data D1 is selected as the address indicating the delivery destination. For the delivery timing, delivery of only the newly purchased item (commodity) 3 or collective delivery of items (commodities) 3 in the current month can be selected. The latter can save the delivery fee. The item (commodity) 3 to be delivered does not necessarily be packaged in the container such as a capsule. When a special effect to show that the item is contained in the capsule is performed, only the commodity which is the physical item may be delivered. The period for collective delivery is not limited to each month, and can be determined as appropriate. The communication unit 11 is connected to the communication line N to perform communications.

The storage unit 12 stores a system program and a function program. The system program is a program for implementing a basic computer function of the item provision management server 1. The function program is a program for making the processing unit 10 function as the item presentation unit 110 (the user information management unit 111, the inventory status management unit 112, the item presentation control unit 113, the mode management unit 114, the lottery processing control unit 115, and the special effect processing unit 116) and as the provision procedure processing unit 120. The storage unit 12 further stores the user information data D1 and the inventory status information data D2.

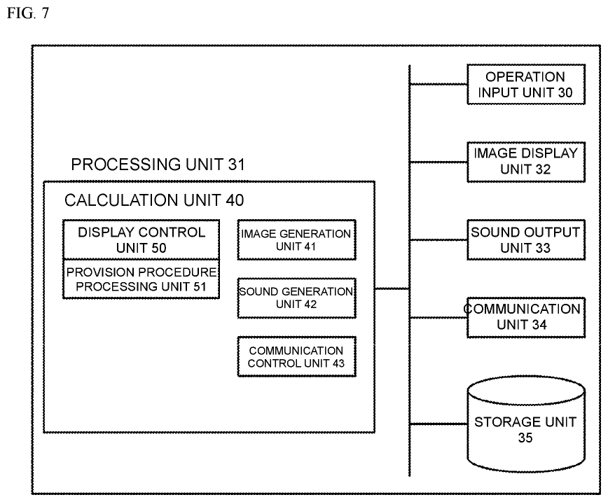

Next, a configuration of the terminal 2 will be described. FIG. 7 is a block diagram illustrating a functional configuration example of the terminal 2.

As illustrated in FIG. 7, the terminal 2 includes an operation input unit 30, a processing unit 31, an image display unit 32, a sound output unit 33, a communication unit 34, and a storage unit 35.

The operation input unit 30 is used by the user to input various operations, and outputs an operation input signal, corresponding to the operation input, to the processing unit 31. The function of the operation input unit 30 can be obviously implemented with an element directly operated by a finger of the user such as a touch operation pad, a home button, a button switch, a joystick, a trackball, and can also be implemented with other elements including elements detecting motions and orientations such as an acceleration sensor, an angular velocity sensor, a tilt sensor, and a geomagnetic sensor. The operation input unit 30 corresponds to the touch operation panel 22 in FIG. 2.

The processing unit 31 performs comprehensive control on an operation of the terminal 2, based on a program and data stored in the storage unit 35, the operation input signal from the operation input unit 30, and the like. For example, the function of the processing unit 31 can be implemented with electronic parts such as a microprocessor (such as a CPU and a GPU), an ASIC, and an IC memory. The processing unit 31 includes, as main functional units, a calculation unit 40, an image generation unit 41, a sound generation unit 42, and a communication control unit 43.

The calculation unit 40 executes various types of processing to implement the purchasing of the item (commodity) 3 of the present embodiment, and outputs the processing result to the image generation unit 41, the sound generation unit 42, and the communication control unit 43. The calculation unit 40 includes a display control unit 50 and a provision procedure processing unit 51.

The display control unit 50 implements displaying of a commodity image and a capsule image of the item (commodity) 3, the special effect, the item (commodity) 3 purchase procedure, and the like, by using information provided by the item provision management server 1 and user operation information.

The provision procedure processing unit 51 implements a provision procedure for an item (commodity) 3 after the purchasing thereof has been completed. Specifically, the provision procedure processing unit 51 performs a procedure for the delivery destination and delivery timing of the item (commodity) 3, with the provision procedure processing unit 120 of the item provision management server 1.

The image generation unit 41 generates one game screen per one frame time ( 1/60 seconds for example) based on the result of the processing by the calculation unit 40, and outputs an image signal corresponding to the generated game screen to the image display unit 32. The function of the image generation unit 41 can be implemented by, for example, a processor such as a GPU, a DSP, a video signal IC, a program such as a video codec, a rendering frame IC memory such as a frame buffer, an IC memory used for expanding texture data, and the like.

The sound generation unit 42 generates a sound signal for a sound effect, various operation sounds, and the like based on a result of processing by the calculation unit 40, and outputs the signal to the sound output unit 33. The function of the sound generation unit 42 can be implemented by a processor such as a DSP and a sound synthesis IC, an audio codec that can replay a sound file, and the like, for example.

The communication control unit 43 executes communication connection and data processing for performing data communications with the terminal manage server 2.

The image display unit 32 displays various game screens based on the image signal received from the image generation unit 41. The function of the image display unit 32 can be implemented by a display device such as a flat panel display, a cathode ray tube (CRT), a projector, a head mounted display, for example. The image display unit 32 corresponds to the display 21 in FIG. 2.

The sound output unit 33 outputs sound such as sound effect and the like, based on the sound signal received from the sound generation unit 42. The sound output unit 33 corresponds to the speaker 23 in FIG. 2.

The communication unit 34 implements communications by connecting to the communication line N. The function of the communication unit 34 can be implemented by a radio communication device, a modem, a terminal adaptor (TA), a jack for a cable for wired communications, a control circuit, and the like.

In the storage unit 35, a program for operating the terminal 2 and implementing various functions of the terminal 2, data used while the program is executed, and the like, are stored in advance or temporarily stored every time the processing is executed. The storage unit 35 can be implemented by a RAM, a ROM, an IC memory such as a flash memory, a magnetic disk such as hard disk, an optical disk such as a CD-ROM and DVD, and the like. Specifically, the storage unit 35 stores a system program and a control program for controlling processing for purchasing the item (commodity) 3 using the terminal 2. The system program is a program for implanting a basic computer function of the terminal 2. The control program is a program for implementing the function of the calculation unit 40 of the processing unit 31.

[Description on Operation]

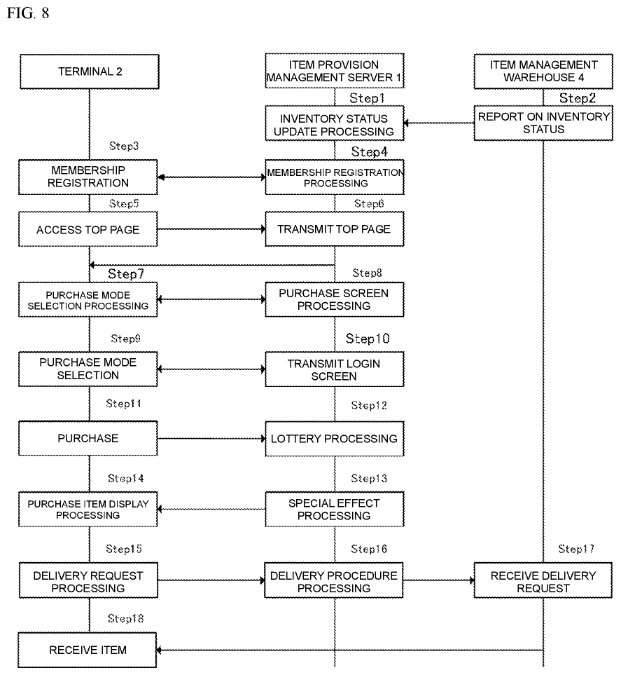

An operation of the item provision system of the present embodiment will be described. FIG. 8 is a sequence diagram of the item provision system of the present embodiment. In the following example, a case where the item (commodity) 3 is a capsule toy will be described.

First of all, the inventory status management unit 111 of the item provision management server 1 receives a report on the inventory status from the item management warehouse 4 (Step 2), and executes inventory status update processing (Step 1). The inventory status update processing (Step 1) is executed with the inventory status information database D2 updated to the latest information. The inventory status update processing is executed periodically, or at a timing when a change in the inventory occurs.

The user performs membership registration (Step 3). With the membership registration, the name and the address of the user, a method for settlement processing using the credit card number, a password, and the like are registered (Step 3). The user information management unit 111 of the item provision management server 1 executes membership registration processing (Step 4). With the membership registration processing, the user ID of the user is issued, and the name and the address of the user, the method for settlement processing using the credit card number or the like, and the password are registered in the user information data D1.

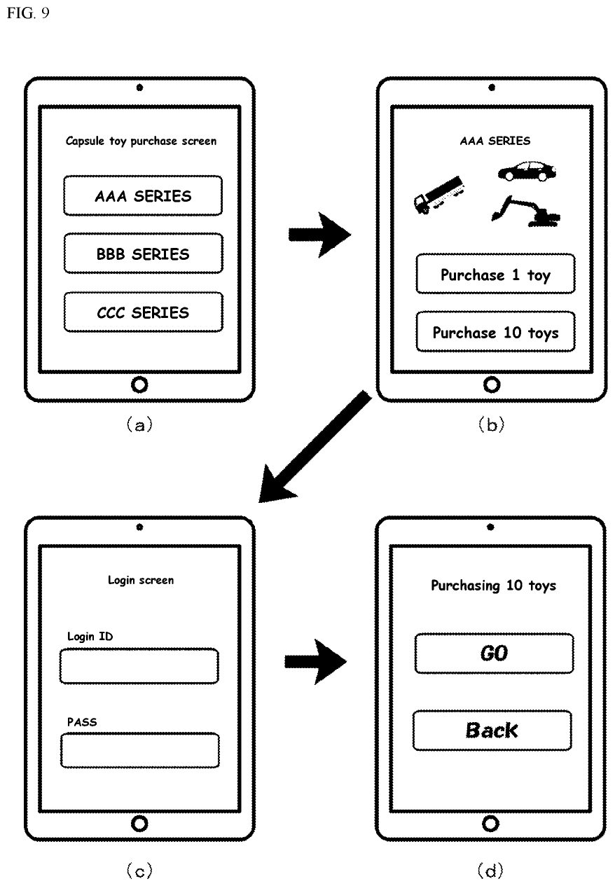

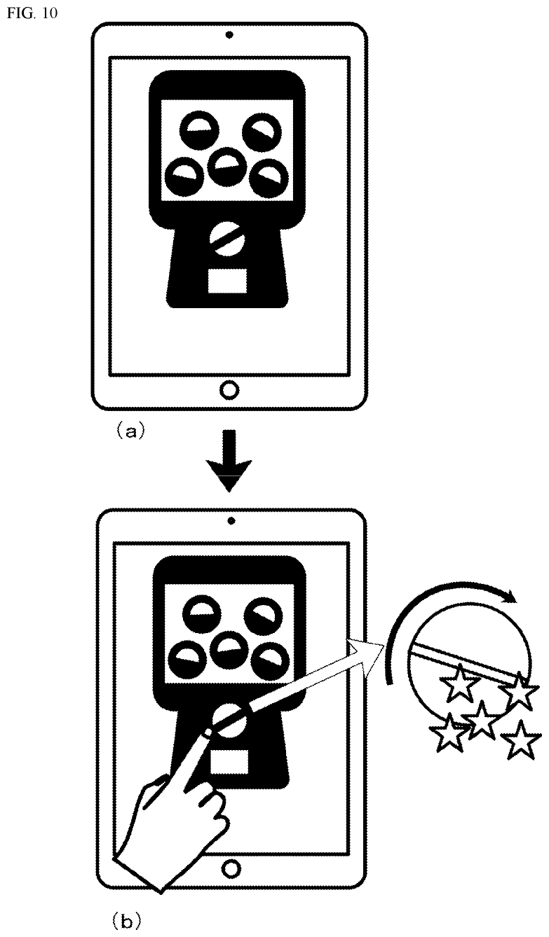

When the user purchases a capsule toy, the user uses the terminal 2 to access the top page of a website selling the capsule toy (Step 5). FIG. 9(a) is a diagram illustrating an example of a top page displayed on the terminal 2.

The item presentation control unit 113 of the item provision management server 1 transmits the top page to the terminal 2 in response to a request from the terminal 2 (Step 6).

The display control unit 50 of the terminal 2 that has received the top page displays the top page and executes purchase mode selection processing (Step 7). On the other hand, the item presentation control unit 113 of the item provision management server 1 executes purchase screen processing (Step 8). The purchase mode selection processing (Step 7) and the purchase screen processing (Step 8) are executed as follows.

The user selects a category of capsule toys desired by the user, on the top page displayed on the terminal 2. The selection is made by touching a button with the name of the category. When the category of the desired capsule toy is selected, the mode management unit 114 of the item provision management server 1 causes transition to a sales screen for each category, and the display control unit 50 of the terminal 2 displays the sales screen for each category. FIG. 9(b) is a diagram illustrating an example of the sales screen displayed on the terminal 2.

The user selects whether to purchase one capsule toy or to purchase 10 capsule toys on the sales screen (Step 9). The selection on the purchase quantity is made by touching a button with the purchase quantity. Here, it is assumed that the user as selected to purchase 10 capsule toys.

When the purchase button is selected, the mode management unit 114 of the item provision management server 1 causes transition to a login screen, and the display control unit 50 of the terminal 2 displays the login screen (Step 10). FIG. 9(c) is a diagram illustrating an example of the login screen displayed on the terminal 2. The user inputs the login ID and password registered in advance. When the user information management unit 111 of the item provision management server 1 determines that the login ID and the password match, the mode management unit 114 of the item provision management server 1 causes transition to a purchase confirmation screen. The display control unit 50 of the terminal 2 displays the purchase confirmation screen. FIG. 9(d) is a diagram illustrating an example of the purchase confirmation screen displayed on the terminal 2.

The user selects a confirm button (GO) when purchasing the capsule toy (Step 11). When the confirm button (GO) is selected, the lottery processing control unit 115 of the item provision management server 1 executes the lottery processing for providing the capsule toy to the user (Step 12). This lottery is performed while taking the sales history and the inventory status into consideration as described above. In a mode for purchasing a plurality of capsule toys, the capsule toy provided to the user selected while also taking the matching rate into consideration.

When the selection (lottery) for the capsule toy provided to the user ends, the special effect processing unit 116 of the item provision management server 1 executes special effect processing for presenting the capsule toy (Step 13).

On the other hand, the display control unit 50 of the terminal 2 of the user executes purchase item display processing (Step 14). The purchase item display processing is executed as follows.

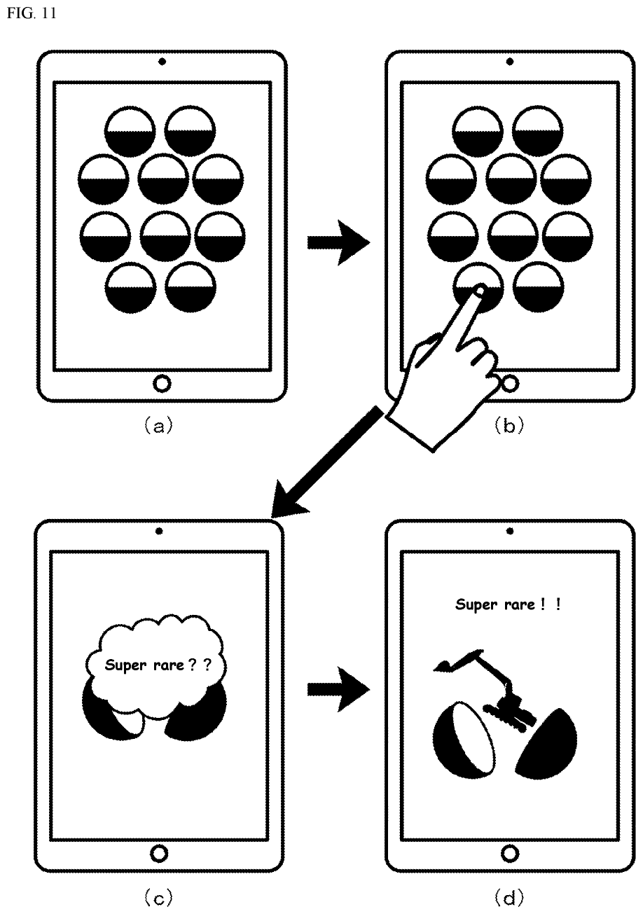

The display control unit 50 of the terminal 2 of the user displays an image of a capsule toy provision device on the screen of the terminal 2. FIG. 10(a) is a diagram illustrating an example of the image of the capsule toy provision device displayed on the screen of the terminal 2.

When the user touches a handle portion in the image of the capsule toy provision device (FIG. 10(b), the handle starts to rotate. Then, a special effect is provided in accordance with the rarity of the capsule toy (item (commodity) 3) selected by the lottery result. For example, when the rarity is 1, a normal handle rotating image is displayed. When the rarity is 2, a special effect image of gold stars twinkling is displayed in addition to the handle rotation image. When the rarity is 3, a special effect image of rainbow colored stars twinkling is displayed in addition to the handle rotating image. When a plurality of capsule toys are provided, the special image is provided in accordance with the highest one of the rarities of these.

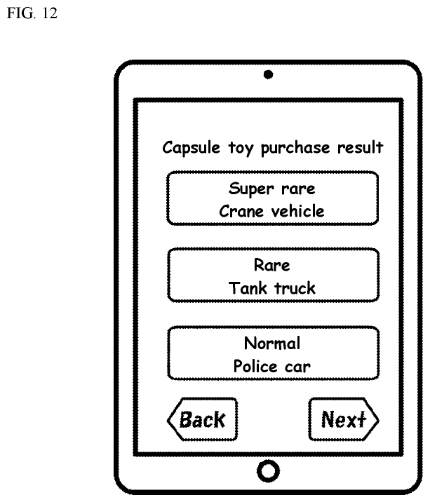

When the displaying of the special effect image stops, the images of the capsule toys are displayed. The number of such images is the same as the number of the capsule toys. FIG. 11(a) is a diagram illustrating 10 capsule toys displayed on the screen of the terminal 2. By touching one capsule toy, the user can check the commodity virtually accommodated in the capsule toy (FIG. 11(b)). When the user touches one capsule toy, an open image of the capsule is displayed. Then, the special effect is displayed in accordance with the rarity of the commodity accommodated in the capsule. For example, a normal open image is displayed when the rarity is 1, a word “rare” is displayed when the rarity is 2, and a word “super rare” is displayed when the rarity is 3 (FIG. 11(c)). Then, the capsule is opened and the commodity image of the commodity that has been accommodated is displayed (FIG. 11(d)). Such processing is executed by the number of times that is the same as the number of capsule toys purchased. When a plurality of items are purchased, the open processing may be executed for all the items at once. When all the capsule toys are opened, a capsule toy purchase result screen is displayed on the terminal 2. FIG. 12 is a diagram illustrating an example of the purchase result screen displayed on the terminal 2.

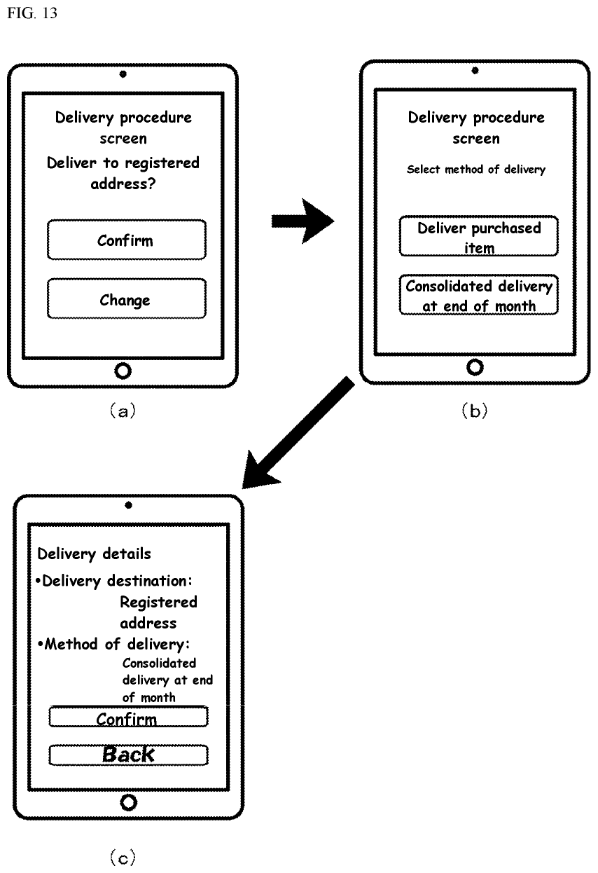

Next, the provision procedure processing unit 51 of the terminal 2 executes delivery request processing (Step 15). The provision procedure processing unit 51 displays a delivery request screen on the terminal 2. FIG. 13 is a diagram illustrating an example of the delivery request screen displayed on the terminal 2.

The provision procedure processing unit 51 of the terminal 2 displays a screen for determining an address indicating the delivery destination of the capsule toy (FIG. 13(a)). The user selects the confirm button to confirm the address as the delivery destination, when the address of the user registered is used as the delivery destination. A change procedure is performed when a change is required.

Next, the provision procedure processing unit 51 of the terminal 2 displays a screen for selecting a delivery method (FIG. 13(b)). With the selection of the delivery method, a delivery method of delivering the currently purchased capsule toy immediately, or a delivery method of collectively delivering capsule toys purchased until the end of the month including the purchase date. With this configuration, when only a single capsule toy is purchased, the delivery fee can be prevented from being high for delivering the single item only. Specifically, when there are items that are scheduled to be purchased in the future, such items can be collectively delivered, whereby the delivery fee can be reduced. The period for the collective delivery is not limited to a month, and may be other periods. When the selection of the delivery method by the user ends, the provision procedure processing unit 51 of the terminal 2 displays a screen for confirming the content of the deliver (FIG. 13(c)). When the confirm button is select, the delivery request processing ends.

Upon receiving the delivery request from the terminal 2, the provision procedure processing unit 120 of the item provision management server 1 executes delivery procedure processing (Step 16). When a request for delivering the currently purchased item is received, in the delivery procedure processing, the name of the user for which the delivery request has been accepted, the address that is the delivery destination, and the item ID identifying the capsule to be delivered to the item management warehouse 4. On the other hand, for the collective delivery at the end of the month, the item ID of the newly purchased item is registered in the purchase history in the user information data D1, with an undelivered flag provided so that it can be recognized that the item has not been delivered. Then, at the end of the month, the item IDs of the undelivered items are collectively transmitted to the item management warehouse 4.

The item presentation control unit 113 of the item provision management server 1 updates the purchase history information in the user information data D1, by registering the item ID of the item currently purchased by the user, and the cumulating amount of the price (cost) paid by the user for purchasing the items to date in the purchase history information.

In the item management warehouse 4, a procedure of receiving a shipping request and delivering the capsule toy of the corresponding item ID to the address indicating the delivery destination (Step 17). Finally, the capsule toy purchased is delivered to the address indicating the delivery destination, and the user receives the capsule toy (Step 18).

In the embodiment described above, after the currently purchased capsule toy (item) has been presented, that is, after the special effect processing (Step 13) and the purchase item display processing (Step 14) have been executed, reward processing of giving a reward to the user may be further executed. For example, the item presentation control unit 113 of the item provision management server 1 may refer to the cumulative amount of the payment for the cost in the purchase history information in the user information data D1, and additionally provide a capsule toy (item) as a reward, in accordance with the cumulative amount. In this case, the delivery request processing is executed (Step 15) for the currently purchased capsule toy (item) as well as for the capsule toy (item) provided as the reward. Furthermore, a commodity image (an image of the commodity that has been accommodated in the capsule toy) of the capsule toy that has been provided so far, may be provided in accordance with the cumulative amount. In this case, the commodity image provided as the reward is transmitted from the item presentation control unit 113 of the item provision management server 1 to the terminal 2, and the terminal 2 can receive and stored the commodity image.

With the present embodiment, an item can be provided to the user over a network, as in a case of an item provision device installed in a stored or the like. The present embodiment is particularly effective for infectious disease prevention, because the user can acquire a physical item without touching the handle of the item provision device or the like. Furthermore, the special effect is provided in accordance with the rarity of the item provided unlike in the case of the physical item provision device, whereby the user can enjoy the special effect during the process of acquiring the physical item. Furthermore, the type of the item provided can be adjusted based on the purchase history of the user and the inventory status of the item unlike in the case of the physical item provision device. Thus, unfairness among users can be addressed.

When the item provision management server 1 has an Application Service Provider (ASP) function and the terminal 2 performs Web-based operations, a configuration similar to that in the embodiment described above can be implemented without installing a special application in the terminal 2.

### First Modification of Embodiment of Present Invention

A first modification of the embodiment of the present invention will be described.

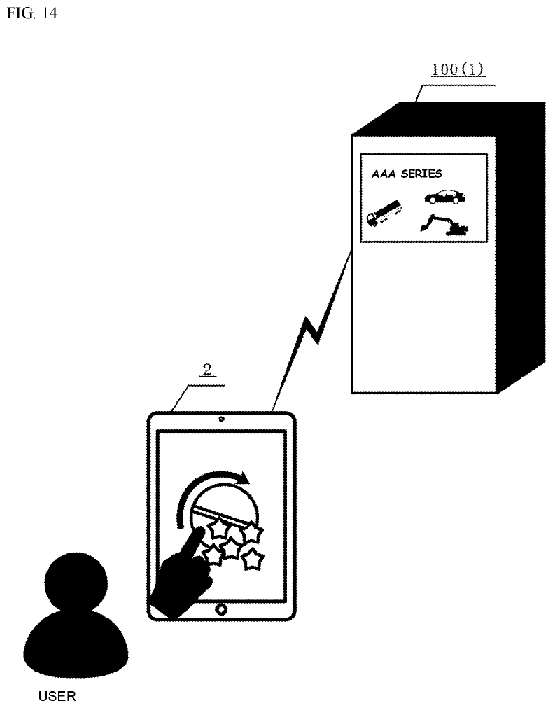

In the embodiment described above, an example is described where the item provision management server 1 is provided on the network. Alternatively, the item provision management server 1 may be included in an item provision device installed in a store or the like. FIG. 14 is a diagram illustrating the first modification of the embodiment of the present invention.

As illustrated in FIG. 14, the item provision management server 1 in a mode of being disguised as an item provision device 100 is installed in a store or the like. The item provision management server 1 disguised as the item provision device 100 can be connected to the terminal 2 using near field communication such as WiFi or Bluetooth.

The terminal 2 can be connected to the item provision management server 1 disguised as the item provision device 100 by, for example, the terminal 2 reading a two-dimensional bar code such as a QR code (registered trademark), with the address of the top page, displayed on the item provision device 100. A procedure as in the above described embodiment is performed after the terminal 2 is connected to the item provision management server 1 disguised as the item provision device 100.

With the first modification of the embodiment, the item provision management server 1 disguised as the item provision device 100 is installed in a limited location such as an event venue to limit the opportunity to acquire the item 3 (capsule toy), so that the rarity of the item can be increased.

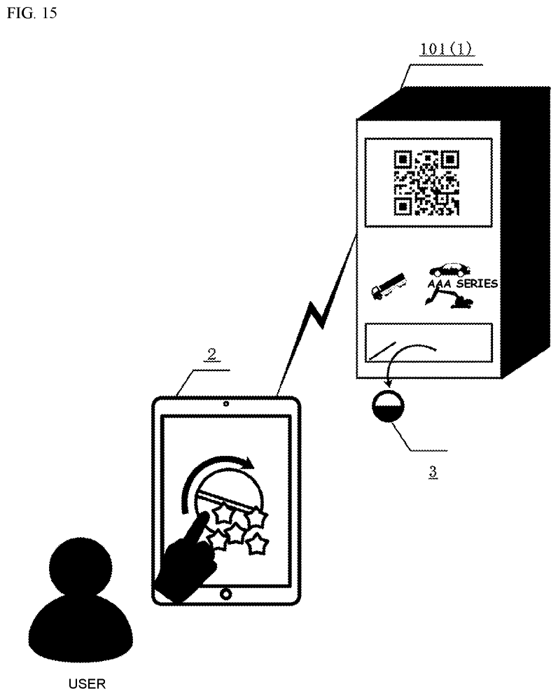

Furthermore, the item provision device 100 may be a physical item provision device 101 that can actually provide an item, instead of being in the disguised mode. FIG. 15 is a diagram illustrating another example of the first modification of the embodiment of the present invention.

Also with the physical item provision device 101, a handle operation for providing the item 3 (capsule toy) is performed on the terminal 2 as in the operation according to the embodiment described above. On the other hand, for providing the physical item 3 (capsule toy), the provision procedure processing unit 120 executes a function of discharging the physical item 3 (capsule toy). When all the physical items 3 (capsule toys) accommodated in the physical item provision device 101 has been discharged, the provision procedure processing unit 120 may perform the delivery procedure as in the embodiment described above.

### Second Modification of Embodiment of Present Invention

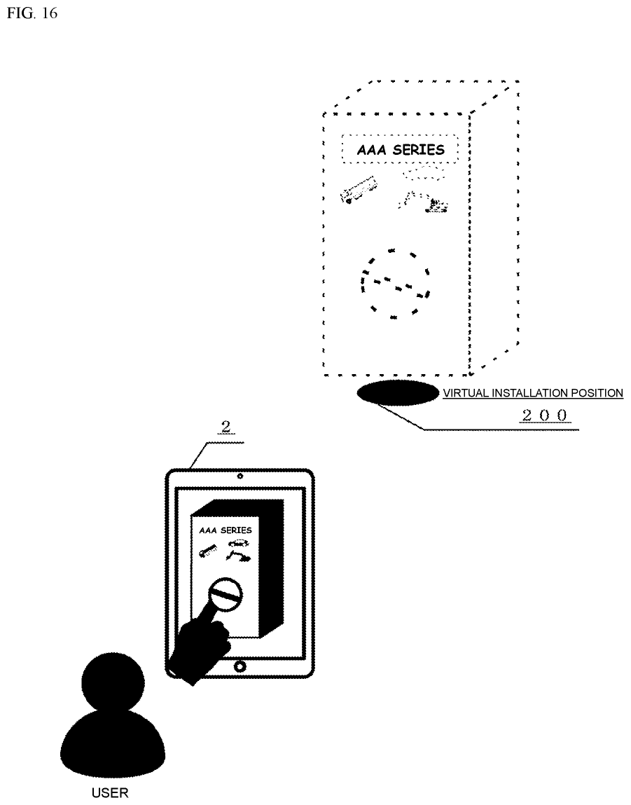

A second modification of the embodiment of the present invention will be described. FIG. 16 is a diagram illustrating the second modification of the embodiment of the present invention.

In the second modification of the embodiment, the item provision device 100 and the physical item provision device 101 are not installed as in the first modification. Instead, position information on the virtual installation position of the item provision device 100 is registered in the item provision management server 1. Then, a marker 200 is provided at the virtual installation position. Alternatively, an existing landmark (such as a building) may be used as the marker 200, instead of newly providing the marker 200.

The user with the terminal 2 accesses the top page upon arriving at the virtual installation position. Then, the terminal 2 transmits the position information acquired by a function of the GPS or the like. The item provision management server 1 compares the received position information on the terminal 2 with the position information on the virtual installation position registered, and allows the access to the top page when they match. Operations thereafter are similar to those in the embodiment described above. With the second modification of the embodiment of the present invention, the item provision device does not need to be actually installed, whereby a load on the service provider can be reduced. Furthermore, the user can have fun finding a location where he or she can acquire the item.

The present invention is described above based on a preferred embodiment. It should be noted that the present invention is not necessarily limited to the embodiment described above, and can be modified in various ways without departing from the technical idea thereof. The embodiments described above are partially or entirely described as in the following notes, but are not limited to these.

### [Note 1]

A program in a terminal communicably connected with a physical item provision management device, the program causing the terminal to function as:
a display control unit capable of displaying an item image corresponding to a physical item and a container image corresponding to a container virtually accommodating the physical item and concealing the physical item; and
a provision procedure control unit enabling, when the item image and the container image are displayed, a provision procedure of providing a user with the physical item corresponding to the item image displayed.

### [Note 2]

The program according to Note 1, wherein the display control unit displays an item provision device image of an item provision device, and displays the container image when the user performs a predetermined operation on the item provision device image.

### [Note 3]

The program according to Note 2, wherein the display control unit displays the item image when the user performs a predetermined operation on the container image displayed.

### [Note 4]

The program according to any one of Notes 1 to 3, wherein the container image is a capsule image, and the item image is a commodity accommodated in a capsule.

### [Note 5]

The program according to any one of Notes 1 to 4, wherein the display control unit performs control to make any one of a plurality of types selectable, and to display a plurality of the item images in association with each of the types.

### [Note 6]

The program according to any one of Notes 1 to 5, wherein the display control unit displays a different item image in accordance with a result of a lottery for physical items provided to the user.

### [Note 7]

The program according to Note 6, wherein the lottery is performed while taking into consideration information that is at least one of provision history information on a physical item provided to the user and inventory status information on the physical item.

### [Note 8]

The program according to Note 6 or 7, wherein rarity is set for each of the physical items, and the lottery is controlled to increase provision probability of the physical item for a higher rarity.

### [Note 9]

The program according to any one of Notes 1 to 8, wherein rarity is set for each of the physical items, and the display control unit provides a special effect for the container image displayed, in accordance with a level of the rarity provided to the physical item.

### [Note 10]

The program according to any one of Notes 1 to 9, wherein rarity is set for each of the physical items, and the display control unit provides a special effect when an open movie is displayed for the container image, in accordance with a level of the rarity provided to the physical item.

### [Note 11]

The program according to any one of Notes 1 to 10, wherein
the display control unit performs control to enable the user to select any one of
   a first mode in which the item image and the container image are each displayed as a single image, and
   a second mode in which the item image and the container image are each displayed as a plurality of images.

[Note 12]

The program according to Note 11, wherein the display control unit performs control, when the second mode is selected, to enable a plurality of the container images to be displayed at once.

### [Note 13]

The program according to Note 11 or 12, wherein the provision procedure control unit enables the provision procedure to be performed for a single physical item when the first mode is selected, and enables the provision procedure to be performed for a plurality of physical items when the second mode is selected.

### [Note 14]

The program according to any one of Notes 11 to 13, wherein the display control unit performs control to enable any of the modes to be selected, when a cost is paid.

### [Note 15]

The program according to Note 14, wherein the first mode is selected when a first cost is paid, the second mode is selected when a second cost is paid, and the second cost is higher than the first cost.

### [Note 16]

The program according to any one of Notes 11 to 15, wherein the display control unit controls, when the second mode is selected, a matching rate of a plurality of item images to be displayed.

### [Note 17]

The program according to Note 16, wherein the matching rate is controlled to be lowered based on information that is at least one of provision history information on a physical item provided to the user and inventory status information on the physical item.

### [Note 18]

The program according to any one of Notes 1 to 17, wherein the provision procedure control unit provides a first reward for providing the physical item or a second reward of providing the item image, in accordance with a cumulative amount of a cost paid by the user.

### [Note 19]

The program according to any one of Notes 1 to 18, wherein the provision procedure control unit controls a provision timing of the physical item to be selectable.

### [Note 20]

The program according to any one of Notes 1 to 19, wherein the provision procedure is a delivery procedure for the user.

### [Note 21]

A physical item provision management device communicably connected with a terminal, the physical item provision management device comprising:

a provision control unit capable of providing a user's terminal with an item image corresponding to a physical item and a container image corresponding to a container virtually accommodating the physical item and concealing the physical item; and a provision procedure control unit enabling, when the item image and the container image are displayed on the terminal, a provision procedure of providing the user with the physical item corresponding to the item image displayed.

### [Note 22]

The physical item provision management device according to Note 21, wherein the provision control unit provides the terminal with an item provision device image of an item provision device, and causes the terminal to display the container image when the user performs a predetermined operation on the item provision device image provided to the terminal.

### [Note 23]

The physical item provision management device according to Note 22, wherein the provision control unit causes the terminal to display the item image when the user performs a predetermined operation on the container image provided to the terminal.

### [Note 24]

The physical item provision management device according to any one of Notes 21 to 23, wherein the container image is a capsule image, and the item image is a commodity accommodated in a capsule.

### [Note 25]

The physical item provision management device according to any one of Notes 21 to 24, wherein the provision control unit performs control to make any one of a plurality of types selectable with the terminal, and to display a plurality of the item images in association with each of the types.

### [Note 26]

The physical item provision management device according to any one of Notes 21 to 25, wherein the provision control unit performs a lottery for physical items provided to the user and provides the terminal with a different item image in accordance with a result of the lottery.

### [Note 27]

The physical item provision management device according to Note 26, wherein the lottery is performed while taking into consideration information that is at least one of provision history information on a physical item provided to the user and inventory status information on the physical item.

### [Note 28]

The physical item provision management device according to Note 26 or 27, wherein rarity is set for each of the physical items, and the lottery is controlled to increase provision probability of the physical item for a higher rarity.

### [Note 29]

The physical item provision management device according to any one of Notes 21 to 28, wherein
rarity is set for each of the physical items, and
the provision control unit provides a special effect for the container image displayed on the terminal, in accordance with a level of the rarity provided to the physical item.

### [Note 30]

The physical item provision management device according to any one of Notes 21 to 29, wherein
rarity is set for each of the physical items, and
the provision control unit provides a special effect when an open movie is displayed for the container image displayed on the terminal, in accordance with a level of the rarity provided to the physical item.

### [Note 31]

The physical item provision management device according to any one of Notes 21 to 30, wherein
the provision control unit performs control to enable the user to select any one of
   a first mode in which the item image and the container image are each displayed as a single image on the terminal, and
   a second mode in which the item image and the container image are each displayed as a plurality of images on the terminal.

### [Note 32]

The physical item provision management device according to Note 31, wherein the provision control unit performs control, when the second mode is selected, to enable a plurality of the container images to be displayed on the terminal at once.

### [Note 33]

The physical item provision management device according to Note 31 or 32, wherein the provision procedure control unit enables the provision procedure to be performed for a single physical item when the first mode is selected, and enables the provision procedure to be performed for a plurality of physical items when the second mode is selected.

### [Note 34]

The physical item provision management device according to any one of Notes 31 to 33, wherein the provision control unit performs control to enable any of the modes to be selected, when a cost is paid.

### [Note 35]

The physical item provision management device according to Note 34, wherein the first mode is selected when a first cost is paid, the second mode is selected when a second cost is paid, and the second cost is higher than the first cost.

### [Note 36]

The physical item provision management device according to any one of Notes 31 to 35, wherein the provision control unit controls, when the second mode is selected, a matching rate of a plurality of item images to be displayed on the terminal.

### [Note 37]

The physical item provision management device according to Note 36, wherein the matching rate is controlled to be lowered based on information that is at least one of provision history information on a physical item provided to the user and inventory status information on the physical item.

### [Note 38]

The physical item provision management device according to any one of Notes 31 to 37, wherein the provision procedure control unit provides a first reward for providing the physical item or a second reward of providing the item image, in accordance with a cumulative amount of a cost paid by the user.

### [Note 39]

The physical item provision management device according to any one of Notes 21 to 38, wherein the provision procedure control unit controls a provision timing of the physical item to the user to be selectable.

### [Note 40]

The physical item provision management device according to any one of Notes 21 to 39, wherein the provision procedure is a delivery procedure for the user.

### [Note 41]

A terminal communicably connected with a physical item provision management device, the terminal comprising:

a display control unit capable of displaying an item image corresponding to a physical item and a container image corresponding to a container virtually accommodating the physical item and concealing the physical item; and
a provision procedure control unit enabling, when the item image and the container image are displayed, a provision procedure of providing a user with the physical item corresponding to the item image displayed.

### [Note 42]

A physical item provision method for a physical item provision management device communicably connected with a terminal, the physical item provision method comprising:
providing a user's terminal with an item image corresponding to a physical item and a container image corresponding to a container virtually accommodating the physical item and concealing the physical item; and
performing, when the item image and the container image are displayed on the terminal, a provision procedure of providing the user with the physical item corresponding to the item image displayed.

### [Note 43]

The physical item provision method according to Note 42, wherein the physical item provision management device provides the terminal with an item provision device image of an item provision device, and causes the terminal to display the container image when the user performs a predetermined operation on the item provision device image provided to the terminal.

### [Note 44]

The physical item provision method according to Note 43, wherein the physical item provision management device causes the terminal to display the item image when the user performs a predetermined operation on the container image displayed on the terminal.

### [Note 45]

The physical item provision method according to any one of Notes 42 to 44, wherein the container image is a capsule image, and the item image is a commodity accommodated in a capsule.

### [Note 46]

The physical item provision method according to any one of Notes 42 to 45, wherein the physical item provision management device performs control to make any one of a plurality of types selectable with the terminal, and to display a plurality of the item images in association with each of the types.

### [Note 47]

The physical item provision method according to any one of Notes 42 to 46, wherein the physical item provision management device performs a lottery for physical items provided to the user and provides the terminal with a different item image in accordance with a result of the lottery.

### [Note 48]

The physical item provision method according to Note 47, wherein the lottery is performed while taking into consideration information that is at least one of provision history information on a physical item provided to the user and inventory status information on the physical item.

### [Note 49]

The physical item provision method according to Note 47 or 48, wherein
rarity is set for each of the physical items, and
the lottery is controlled to increase provision probability of the physical item for a higher rarity.

### [Note 50]

The physical item provision method according to any one of Notes 42 to 49, wherein
rarity is set for each of the physical items, and
the physical item provision management device provides a special effect for the container image displayed on the terminal, in accordance with a level of the rarity provided to the physical item.

### [Note 51]

The physical item provision method according to any one of Notes 42 to 50, wherein rarity is set for each of the physical items, and
the physical item provision management device provides a special effect when an open movie is displayed for the container image displayed on the terminal, in accordance with a level of the rarity provided to the physical item.

### [Note 52]

The physical item provision method according to any one of Notes 42 to 51, wherein
the physical item provision management device performs control to enable the user to select any one of
   a first mode in which the item image and the container image are each displayed as a single image on the terminal, and
   a second mode in which the item image and the container image are each displayed as a plurality of images on the terminal.

### [Note 53]

The physical item provision method according to Note 52, wherein the physical item provision management device performs control, when the second mode is selected, to enable a plurality of the container images to be displayed on the terminal at once.

### [Note 54]

The physical item provision method according to Note 52 or 53, wherein the physical item provision management device enables the provision procedure to be performed for a single physical item when the first mode is selected, and enables the provision procedure to be performed for a plurality of physical items when the second mode is selected.

### [Note 55]

The physical item provision method according to any one of Notes 52 to 54, wherein the physical item provision management device performs control to enable any of the modes to be selected, when a cost is paid.

### [Note 56]

The physical item provision method according to Note 55, wherein the first mode is selected when a first cost is paid, the second mode is selected when a second cost is paid, and the second cost is higher than the first cost.

### [Note 57]

The physical item provision method according to any one of Notes 52 to 56, wherein the physical item provision management device controls, when the second mode is selected, a matching rate of a plurality of item images to be displayed on the terminal.

### [Note 58]

The physical item provision method according to Note 57, wherein the matching rate is controlled to be lowered based on information that is at least one of provision history information on a physical item provided to the user and inventory status information on the physical item.

### [Note 59]

The physical item provision method according to any one of Notes 42 to 58, wherein the physical item provision management device provides a first reward for providing the physical item or a second reward of providing the item image, in accordance with a cumulative amount of a cost paid by the user.

### [Note 60]

The physical item provision method according to any one of Notes 42 to 59, wherein the physical item provision management device controls a provision timing of the physical item to the user to be selectable.

### [Note 61]

The physical item provision method according to any one of Notes 42 to 60, wherein the provision procedure is a delivery procedure for the user.

### REFERENCE SIGNS LIST

1 item provision management server
2 terminal
3 item
4 item management warehouse
5 capsule toy
6 toy
7 capsule

1.-20. (canceled)

21. A management apparatus comprising;
a processor and a non-volatile computer readable memory in which a computer code is stored,
wherein, based on the computer code stored in the non-volatile memory,
the processor
manages an inventory status information of items,
displays, on a terminal, a purchase screen for purchasing at least one of the items,
performs a lottery for the at least one of the items to be provided, by using the inventory status information of the items when an item purchase procedure is completed,
determines the at least one of the items to be provided based on a lottery result, and
presents an item image of the determined at least one of the items on the terminal.

22. The management apparatus according to claim 21, wherein the lottery is performed with a first extraction probability when an item inventory is at a predetermined level or lower, and the lottery is performed at a second extraction probability when a level of the item inventory is higher than the predetermined level.

23. The management apparatus according to claim 22, wherein the lottery is performed using a method of weighting a value reflecting the inventory, with respect to the original extraction probability may be employed.

24. The management apparatus according to claim 23, wherein rarity is set for each of the items, and an originally set extraction probability of the at least one of the items is decreased when a rarity is higher than a predetermined value.

25. The management apparatus according to claim 22, wherein a plurality of items with one time purchase procedure is provided, and the lottery for the at least one of the items to be provided, is performed so as to reduce a duplicate item rate.

26. The management apparatus according to claim 21, wherein an item image corresponding to the at least one of the items and a container image corresponding to a container virtually accommodating the items are presented on the terminal, and the at least one of the items determined based on the lottery result is concealed on the terminal.

27. The management apparatus according to claim 26, wherein a rarity is set for each of the items; and a special effect is presented when an open movie is displayed for the container image, in accordance with a level of the rarity assigned to the at least one of the items.

28. The management apparatus according to claim 21, wherein a plurality of selection buttons for delivery methods of delivering the currently purchased at least one of the items is presented on the terminal, information of a selected delivery method is received from the terminal, and the delivery procedure according to the selected delivery method is performed.

29. The management apparatus according to claim 28, wherein the selection buttons include a button for a delivery method by which the at least one of the items purchased this time is delivered and a button for a delivery method by which items purchased by an end of a month of a purchase date are collectively delivered.

30. The management apparatus according to claim 21, wherein a reward is provided in accordance with a cumulative amount of a cost paid by a user.

31. The management apparatus according to claim 30, wherein an item is given away as the reward.

32. The management apparatus according to claim 21, further comprising a database including virtual installation location information of an item provision device,
wherein location information of the terminal is received,
the location information of the terminal is compared with the virtual installation location information, and
the purchase screen is presented on the terminal when the location information of the terminal matches with the virtual installation location information.

33. The management apparatus according to claim 32, wherein a marker is provided at a virtual installation location.

34. The management apparatus according to claim 32, wherein the marker is a landmark.

35. A management apparatus comprising:
a processor, and
a non-volatile computer readable memory in which computer code is stored,
wherein, based on the computer code stored in the non-volatile memory,
the processor
manages an inventory status information on the item,
presents a purchase screen for purchasing at least one of items on a terminal,
when an item purchase procedure is completed and an item inventory is at a predetermined level or lower, performs a lottery for the at least one of the items to be provided with a first extraction probability,
performs the lottery with a second extraction probability when a level of the item inventory is higher than the predetermined level,
determines the at least one of the items to be provided based on a lottery result,
presents an item image of the determined item on the terminal,
presents selection buttons for delivery methods of delivering the currently purchased at least one of the items on the terminal, the delivery methods including a delivery method by which the at least one of the items purchased this time, and a delivery method by which items purchased by an end of a month of a purchase date are collectively delivered,
receives selected one of the delivery methods from the terminal, and
performs the delivery procedure according to the selected one of the delivery methods.

36. An item provide system comprising:
a management apparatus and
a terminal,
wherein the management apparatus comprises a processor and a non-volatile computer readable memory in which a computer code is stored,
the processor
manages an inventory status information of items,
displays, on a terminal, a purchase screen for purchasing at least one of the items,
performs a lottery for the at least one of the items to be provided, by using the inventory status information of the items when the item purchase procedure is completed,
determines the at least one of the items to be provided based on a lottery result,
presents an item image of the determined at least one of the items on the terminal,
presents a plurality of selection buttons for delivery methods of delivering the currently purchased at least one of the items on the terminal,
receives selected one of the delivery methods from the terminal, and
performs the delivery procedure according to the selected one of the delivery methods; and
wherein the terminal comprises a processor and a non-volatile computer readable memory, in which a computer code is stored,
based on the computer code stored in computer code stored in the non-volatile memory, the processor
displays the purchase screen,
displays the item image of the determined at least one of the items,
displays the selection buttons, and
requests the delivery method for the currently purchased at least one of the items by selecting the selection buttons.

37. The item provide system according to claim 36, wherein the lottery is performed with a first extraction probability when an item inventory is at a predetermined level or lower and the lottery is performed with a second extraction probability when a level of the item inventory is higher than the predetermined level.

38. The item provide system according to claim 16, wherein the selection buttons include a button for a delivery method by which the at least one of the items purchased this time is delivered, and a button for a delivery method by which items purchased by an end of a month of purchase date are collectively delivered.

39. The item provide system according to claim 36, wherein the management apparatus further comprises a database including virtual installation location information of an item provision device, and
the management apparatus
receives location information of a terminal,
compares the location information of the terminal with the virtual installation location information, and
presents the purchase screen on the terminal when the location information of the terminal matches with the virtual installation location information; and
the terminal,
obtains the location information of the terminal, and
sends the location information of the terminal to the management apparatus.

40. The item provide system according to claim 39, wherein a marker is provided at a virtual installation location, and the terminal obtains the location information of the marker.
